(19) United States
(12) Patent Application Publication
(10) Pub. No.: US 2012/0101638 A1
(43) Pub. Date: Apr. 26, 2012

(54) OPTIMUM PROPORTIONAL-INTEGRAL-DERIVATIVE (PID) CONTROL METHOD FOR ADAPTING A PROCESS FACILITY SYSTEM

(75) Inventor: YAO-HSING LIN, TAOYUAN 333 (TW)

(73) Assignee: CHAN LI MACHINERY CO., LTD., Taoyuan 333 (TW)

(21) Appl. No.: 13/206,553

(22) Filed: Aug. 10, 2011

(30) Foreign Application Priority Data
Oct. 22, 2010 (TW) 099136089

(51) Int. Cl. G05D 7/06

(52) U.S. Cl. 700/282

(57) ABSTRACT

An optimum PID control method for adapting a process facility system is provided. The process facility system includes a primary supply apparatus, a final control element, process facility, a PID controller, and a PID optimization module. When the PID optimization module identifies the primary supply apparatus is switched from an operating status to a shut-down status, the PID optimization module stores a control parameter value of the final control element that is present at the time when the shut down is made in a parameter value memory. Afterwards, when the PID optimization module detects the primary supply apparatus being switched back to the operating status, the PID optimization module retrieves the control parameter value from the parameter value memory and controls the final control element in such a way to have the final control element returning to a position before the shut down with a resumption parameter value and the control parameter value stored in the parameter value memory, whereby optimum PID control can be realized for the process facility in a non-continuous (batch) process.

### BACKGROUND OF THE INVENTION

1. Field of the Invention

The present invention relates generally to an optimum proportional-integral-derivative (PID) control method of process facility system, and in particular to an optimum PID control method for adapting a process facility system that controls the operation of the process facility in a non-continuous process.

2. The Related Arts

Referring to FIG. 1 of the attached drawings, a schematic view illustrating a conventional process facility system is shown. The conventional process facility system 100 comprises a heater 110 that uses steam 106 to heat low temperature water 108 in order to generate high temperature water 112 at a desired temperature. The method for generating the high temperature water 112 is that an operator 114 manually controls a steam valve 104 to regulate the flow rate of steam 106 and visually reads a temperature indicator 102 in order to control the heating rate of the heater 110. With the progress of technology, to raise the operation efficiency and improve product passing rate, modern work shops adopt automatic facility by using machines to replace human power. This saves time and significantly improves the operation efficiency.

Referring to FIG. 2, a schematic view illustrating a PID controller based process facility system is shown. As shown in FIG. 2, the process facility system 200 comprises an automatic control valve 202, an ON-OFF valve 204, a PID (Proportional-Integral-Derivative) controller 206, a temperature sensor 208, and a heater 210. Compared with the process facility system 100 shown in FIG. 1, the process facility system 200 FIG. 2 uses the automatic control valve 202, the PID controller 206, and the temperature sensor 208 to replace the manual operation. The PID controller 206 uses an error or difference between a set point SP and a process value PV (Process Value), such as temperature by receiving a temperature signal S11 from the temperature sensor 208 that is transmitted to the PID controller 206 to be subjected to processing by the PID controller 206, in order to supply a control signal S12 to the automatic control valve 202 for regulating the process value, and thus realizing the purposes of control.

Referring to FIGS. 3 and 4, FIG. 3 is a schematic view illustrating another example of a PID controller based process facility system 300; and FIG. 4 is a flow chart of a method controlling the process facility system 300 of FIG. 3. The process facility system 300 comprises a final control element 302 (which can be a control valve), an ON-OFF valve 304 (or pump), a PID controller 306, a facility detection element 308, and a process facility 310. The PID controller 306 uses an error or difference between a set point SP and a process value PV, such as temperature, pressure, liquid level, and flow rate by receiving a detection signal S13 transmitted from the facility detection element 308 to the PID controller 306 and subjected to processing by the PID controller 306 to supply a control signal S14 to the final control element 302 for regulating the process value, and thus realizing the purposes of control.

A control method of the conventional process facility system is shown in FIG. 4. Firstly, the ON-OFF valve 304 is activated (Step 401); the final control element 302 is set to a desired position through manual operation (Step 402); a determination is made to identify if the final control element 302 reaches the desired position? (Step 403); if the final control element 302 in on the desired position, the operation is switched from manual operation to automatic operation and setting values are set to allow the PID controller 306 to carry out automatic control (Step 404); the PID controller 306 determines if the ON-OFF valve 304 is closed? (Step 405); and finally, the PID controller 306 compulsorily sets the final control element to a safety position (such as 0%, 100%, or any desired position) (Step 406).

The PID controller is of great use for process automization and is very useful for processes that are controlled in a continuous fashion. However, for a non-continuous (namely batch) process, a great error or difference (SP-PV) often exists at the starting point of the control operation and this great error makes it not possible for the PID controller to get effective. Improper application of the controller to perform automatic control may sometimes lead to damage of the facility or undesirably exceed an unstable period of time of control, both causing troubles to the users. Although, using a controller to perform automatic control may save the manual operation by an operator, yet the operator must deliberately handle the troubles caused by such an error. Apparently, this is not fit to the needs of automatic control.

The PID controller is effective for processes of continuous control, but most manufacturing processes require a primary supply apparatus (such as a pumping machine, a pump, a valve, and the likes). Consequently, most of the manufacturing processes run like a batch control at the initial stage of the process and this makes the initial stage of the process the tough part of the process and most processes are designed for continuous operation. Although continuous operation is advantageous, not all the processes are fit to continuous operation as the optimum operation. Thus, it is a major challenge for the industry to overcome such a problem.

### SUMMARY OF THE INVENTION

Accordingly, a primary objective of the present invention is to provide an optimum PID (Proportional-Integral-Derivative) control method, which effectively overcomes the problem of ineffective control of PID control loop at the initial stage of a non-continuous (batch) process due to the significant error so that the non-continuous (batch) process may benefit from the advantages of a continuous type process facility system.

Another objective of the present invention is to provide an optimum PID control method for adapting a process facility system, which is applicable to process solution facility that comprises multiple PID controllers to convert a complicated sequential control into a simple one and to allow quick reach to the original setting and steady state of process control in a short period of time.

A further objective of the present invention is to provide an optimum PID control method for adapting a process facility system, which allows process facility of continuous control to switch back to batch control in order to realize energy saving and carbon reduction for environmental protection.

### BRIEF DESCRIPTION OF THE DRAWINGS

The present invention will be apparent to those skilled in the art by reading the following description of preferred embodiments of the present invention, with reference to the attached drawings, in which:

FIG. 1 is a schematic view illustrating a conventional process facility system;

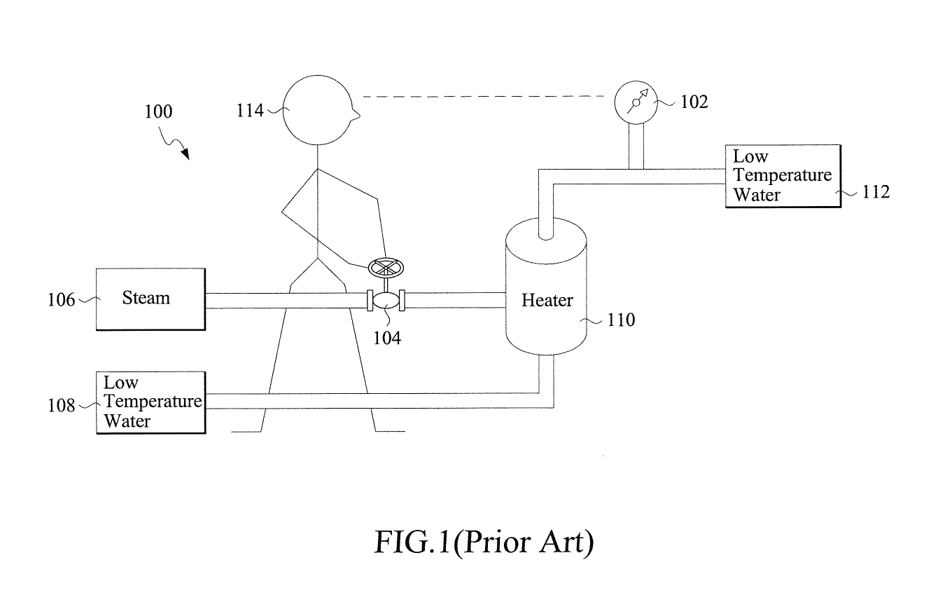

FIG. 2 is a schematic view illustrating a conventional PID (Proportional-Integral-Derivative) controller based process facility system;

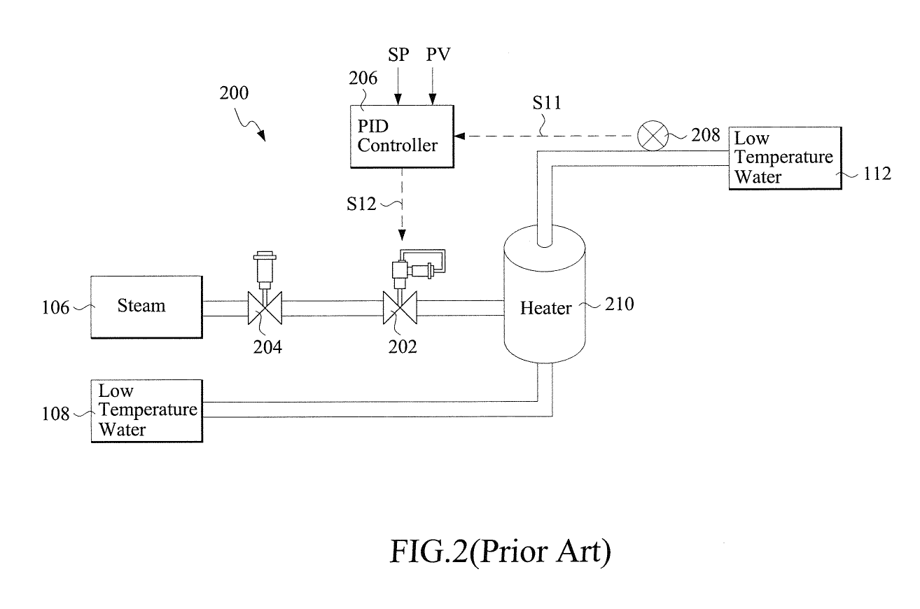

FIG. 3 is a schematic view illustrating another conventional PID controller based process facility system;

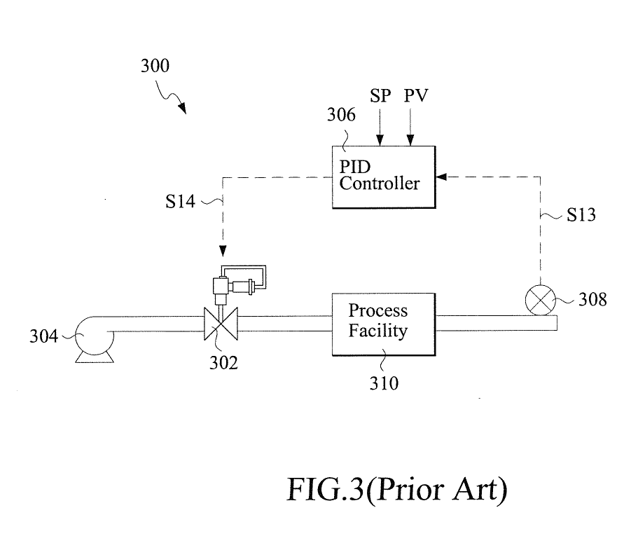

FIG. 4 is a flow chart of a method controlling the process facility system of FIG. 3;

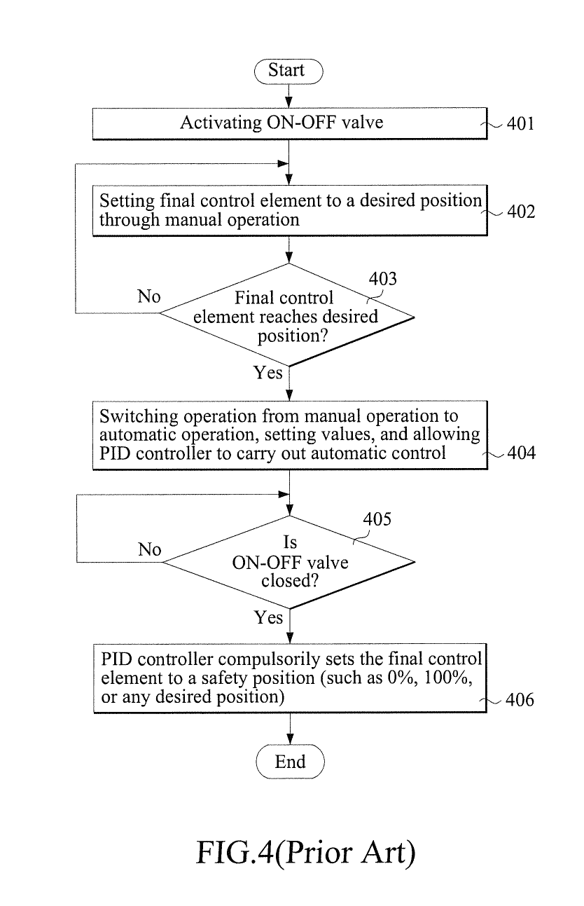

FIG. 5 is a schematic view showing a process facility system to which an optimum PID (Proportional-Integral-Derivative) control method of process facility system according to the present invention is applicable;

FIG. 6 is a flow chart of the method for controlling the process facility system of FIG. 5 according to the present invention; and

FIG. 7 is a schematic view illustrating a detailed system diagram of a preferred embodiment of the present invention.

### DETAILED DESCRIPTION OF THE PREFERRED EMBODIMENTS

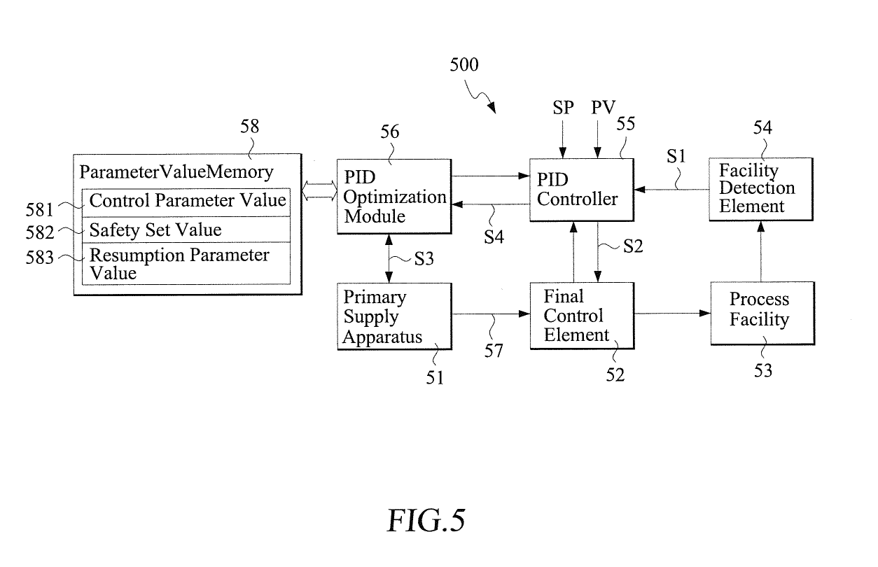

With reference to the drawings and in particular to FIG. 5, a process facility system 500 comprises a primary supply apparatus 51, a final control element 52, process facility 53, a facility detection element 54, a PID (Proportional-Integral-Derivative) controller 55, and a PID optimization module 56. The primary supply apparatus 51 is connected to a piping system 57 and the final control element 52 to the process facility 53. In a normal operation of the primary supply apparatus 51, the final control element 52 is controlled by the PID controller 55 to allow the primary supply apparatus 51 to supply a material through the final control element 52 to the process facility 53.

In a practical application, the primary supply apparatus 51 can be for example a pumping machine, a pump, or an ON-OFF valve; the final control element 52 can be a diaphragm valve; the process facility 53 can be tank (or piping line); the material can be high temperature water, steam, pulp, and the likes; and the facility detection element 54 can be a temperature sensor, a pressure sensor, and the likes.

The PID controller 55 is operated with an error between a set point SP and a process value PV, such as temperature, pressure, liquid level, and flow rate, whereby a detection signal S1 is generated by and transmitted from the facility detection element 54 to the PID controller 55, and is subjected to processing by the PID controller 55 to supply a control signal S2 to the final control element 52 to realize PID control.

The PID optimization module 56 is electrically connected between the PID controller 55 and the primary supply apparatus 51 and is provided with a parameter value memory 58. The parameter value memory 58 stores therein at least one control parameter value 581, a safety set value 582, and a resumption parameter value 583. The primary supply apparatus 51 and the final control element 52 are not each limited to one in quantity and can be of more than one.

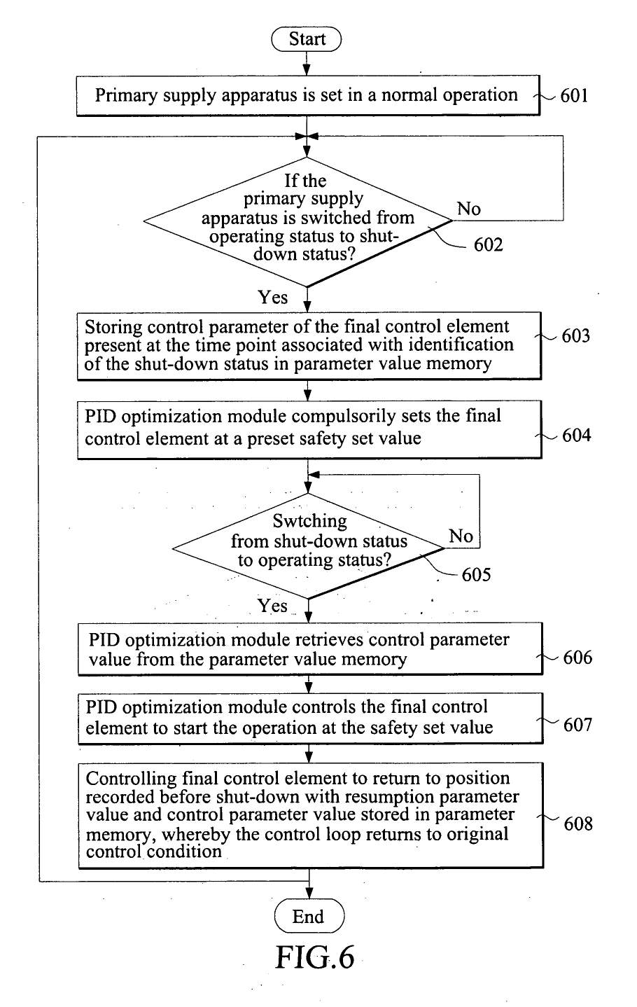

Referring to both FIGS. 5 and 6, an explanation will be given to a flow chart of the method according to the present invention. Firstly, when the primary supply apparatus 51 is set in a normal operation (Step 601), the PID optimization module 56 uses a primary supply apparatus status signal S3 to identify if the primary supply apparatus 51 is switched from an operating status to a shut-down status (Step 602). If it is identified that the primary supply apparatus 51 is in a shut-down status (such as stopping supplying the material), then the PID optimization module 56 stores a control parameter S4 of the final control element 52 that is present at the time point associated with the identification of the shut-down status in the parameter value memory 58 (Step 603) as a control parameter value 581.

The control parameter value 581 can also be obtained by supplying the control signal S2 that supplied from the PID controller 55 to the final control element 52 at the time point of the identification of the shut-down status to serve as the control parameter value 581.

Under this condition, the PID optimization module 56 compulsorily sets the final control element 52 at a preset safety set value 582 (Step 604). The purpose of compulsory setting of the final control element 52 at the safety set value 582 is to prevent any potential risk of fault operation or undesired damage of the process facility system 500 after the process facility 53 stops operations. The safety set value 582 can be built in the system in advance or can be any safety position selected by a user. For example, in the case that the final control element 52 comprises a valve, the safety set value can be that the final control element 52 is set at a 0% position (being closed or shut down or a 100% position (being fully open).

The PID optimization module 56 continuously monitors the status of the primary supply apparatus status signal S3 to identify when the primary supply apparatus 51 switches from the shut-down status to the operating status again (Step 605). When the PID optimization module 56 identifies that the primary supply apparatus 51 resumes the operating status, the PID optimization module 56 retrieves the control parameter value 581 from the parameter value memory 58 (Step 606).

Then, the PID optimization module 56 controls the final control element 52 to start the operation at the safety set value 582 (Step 607), and controls the final control element 52 to return to the position recorded before shut-down with the resumption parameter value 583 and the control parameter value 581 stored in the parameter value memory 58 (Step 608), whereby the control loop may return to the original control condition.

The resumption parameter value 583 allows the PID controller 55 to return the final control element 52 back to the original position before the primary supply apparatus 51 is shut down at a predetermined rate (%/second) within a predetermined period of time (seconds).

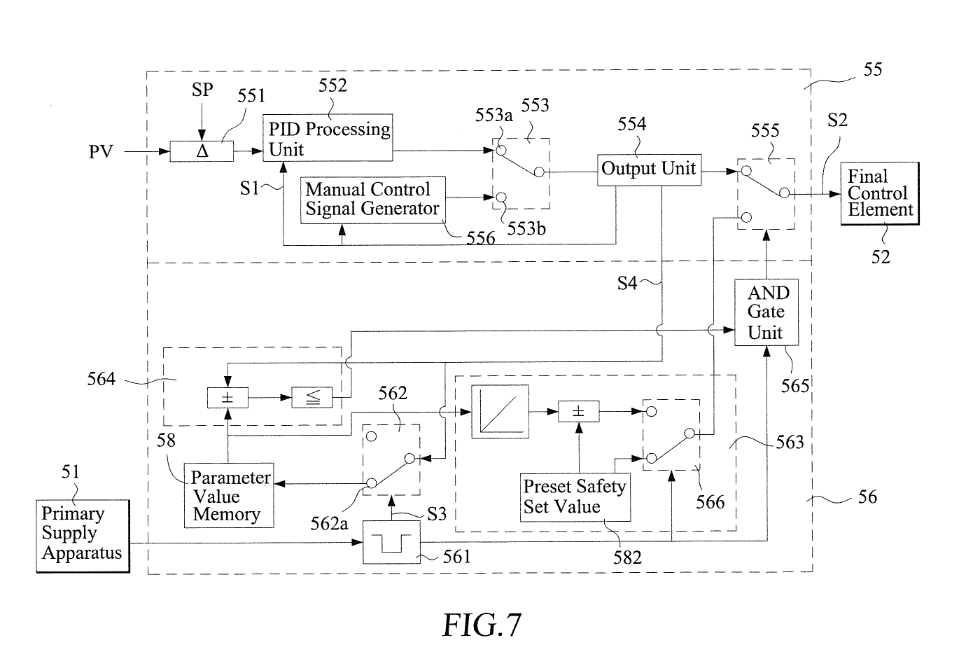

Referring to FIG. 7, a detailed system diagram of a preferred embodiment of the present invention is shown. The PID controller 55 uses an error or difference value 551 between the set point SP and the process value PV (such as temperature, pressure, liquid level, flow rate, and the likes), and a feedback of detection signal 51, which are subjected to predetermined processing by the PID processing unit 552, to supply a control signal S2 through an automatic/manual switch unit 553, an output unit 554, and an output switch unit 555 to the final control element 52. When the automatic/manual switch unit 553 is set at an automatic position 553a, the automatic control is performed; when the automatic/manual switch unit 553 is set at a manual position 553b, a manual control signal generator 556 supplies a manual control signal, which is supplied as a control signal S2 for manual operation through the output unit 554 and the output switch unit 555 to the final control element 52.

The PID optimization module 56 comprises, mainly, a facility status detection unit 561, a signal retrieval path unit 562, a safety control unit 563, a PID optimization parameter error comparison unit 564, an AND gate unit 565, a path switching unit 566, and a parameter value memory 58.

When the primary supply apparatus 51 is in a normal operation, the PID controller 55 carries out a normal PID control operation. When the primary supply apparatus 51 is switched from an operating status to a shut-down status, the facility status detection unit 561 identifies such a switching, and under this condition, the signal retrieval path unit 562 is switched to position 562a, whereby the control parameter S4 supplied by the output unit 554 of the PID controller 55 at that moment will be conveyed through the signal retrieval path unit 562 to be stored as the control parameter value 581 in the parameter value memory 58.

Under this condition, the PID optimization module 56 sets the final control element 52 at a preset safety set value 582 by retrieving and supplying the safety set value 582 that is set up in the safety control unit 563 through the path switching unit 566 and the output switch unit 555. For example, the final control element can be set at a 0% position (being closed or shut down) or a 100% position (being fully open).

When the PID optimization module 56 detects that the primary supply apparatus is resuming an operating status from the shut-down status, the PID optimization parameter error comparison unit 564 controls the final control element 52 according to the control parameter value 581 stored in the parameter value memory 58, and the PID optimization module 56 controls the final control element 52 to start operation at the safety set value 582 and allows the final control element 52 to return to the original position before shut down with the resumption parameter value 583, whereby the control loop may return to the original control condition.

It is noted here that the above description is given as an illustrative example and it is apparent to those skilled in the art that various modifications can be made without departing from the teachings given above. The preferred embodiments given above are for the purposes of illustration rather being limitative, and those having ordinary skills in the art may make various change and alternatives without departing the scope of the present invention.

In summary, the present invention provides an optimum PID control method for a process facility system to solve the problem of causing significant error in the application of a conventional PID controller in the control of a non-continuous (batch) manufacturing process of a process facility, and thus a non-continuous (batch) may be benefit from the advantages of continuous control.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An optimum PID control method for adapting a process facility system, wherein the process facility system comprises at least one primary supply apparatus, at least one final control element, a process facility, a PID controller, and a PID optimization module;
wherein the PID optimization module comprises a parameter value memory and is electrically connected to the PID controller, the primary supply apparatus is connected through a piping system and the final control element to the process facility;
wherein when the primary supply apparatus is in operation, the final control element is controlled by the PID controller to allow the primary supply apparatus to supply a material through the final control element to the process facility, the method comprising the following steps:
(a) determining whether the primary supply apparatus is switched from an operating status to a shut-down status by the PID optimization module;
b) if the primary supply apparatus being in the shut-down status, the PID optimization module storing a control parameter value of the final control element that is present at the time point when the shut-down status is identified in the parameter value memory;
(c) determining whether the primary supply apparatus is switched from the shut-down status to an operating status again by the PID optimization module;
(d) if the primary supply apparatus being switched to the operating status again, the PID optimization module retrieving the control parameter value from the parameter value memory; and
(e) controlling the final control element in such a way to have the final control element returning to a position before the shut-down status with a resumption parameter value and the control parameter value stored in the parameter value memory.

2. The optimum PID control method for adapting a process facility system as claimed in claim 1, wherein in step (a), when the PID optimization module identifies that the primary supply apparatus is in operation, the PID optimization module successively detects if the primary supply apparatus is in operation.

3. The optimum PID control method for adapting a process facility system as claimed in claim 1, wherein in step (c), when the PID optimization module identifies the primary supply apparatus is shut down, the PID optimization module successively detects if the primary supply apparatus is switched to an operating status.

4. The optimum PID control method for adapting a process facility system as claimed in claim 1, wherein after step (b), a step that the PID optimization module further sets the final control element at a preset safety set value is included, and wherein in step (e), the PID optimization module controls the final control element to start operation at the safety set value.

5. The optimum PID control method for adapting a process facility system as claimed in claim 1, wherein the resumption parameter value is pre-set in the parameter value memory.
